(19) United States
(12) Patent Application Publication
(10) Pub. No.: US 2015/0266054 A1
(43) Pub. Date: Sep. 24, 2015

(54) COATING APPARATUS, AND METHOD FOR PRODUCING COATING FILM

(71) Applicant: NITTO DENKO CORPORATION, Osaka (JP)

(72) Inventors: Makoto Komatsubara, Ibaraki-shi (JP); Masashi Miyake, Ibaraki-shi (JP); Minoru Yagi, Ibaraki-shi (JP)

(73) Assignee: NITTO DENKO CORPORATION, Osaka (JP)

(21) Appl. No.: 14/615,827

(22) Filed: Feb. 6, 2015

(30) Foreign Application Priority Data
Mar. 18, 2014 (JP) 2014-055445

(51) Int. Cl. B05D 1/30; B05C 5/00

(52) U.S. Cl. CPC B05D 1/30; B05C 5/00

(57) ABSTRACT

Provided is a coating apparatus that included a coating unit that coats a target to be coated with a coating liquid; a housing unit that houses the coating liquid to be supplied to the coating unit; and a conduit that supplies the coating liquid from above into the housing unit, in which the conduit has an end portion on a side through which the coating liquid is discharged, the end portion being provided with an opening portion through which the coating liquid is discharged, and a bent portion that is bent so as to have the opening portion directed upward.

### CROSS-REFERENCE TO RELATED APPLICATION

This application claims priority to Japanese Patent Application No. 2014-055445 filed on Mar. 18, 2014, the disclosure of which is incorporated herein by reference in its entirety.

### BACKGROUND OF THE INVENTION

1. Field of the Invention

The present invention relates to a coating apparatus, and a method for producing a coating film.

2. Background Art

There is known a die coater provided with a die that coats a target to be coated such as a sheet member with a coating liquid, as one of conventional coating apparatuses. The die coater includes a housing unit that houses the coating liquid, a die as a coating unit a first conduit that supplies the coating liquid into the housing unit, and a second conduit that is connected to the housing unit and the coating unit to supply the coating liquid to the coating unit from the housing unit. The coating liquid supplied into the housing unit through the first conduit is supplied through the second conduit to the coating unit that discharges the coating liquid onto the target to be coated, thereby forming a coating film on the target to be coated.

According to the normal operation of the above coating apparatus, following the supply of a certain amount of the coating liquid into the housing unit, the supply of the coating liquid is stopped, and when the coating liquid within the housing unit is decreased due to the coating operation by the coating unit, the supply of the coating liquid into the housing unit is resumed.

For the coating apparatus of the above type, there is proposed a configuration, in which the first conduit has a linear shape (or a linear shape achieved by natural extension), and an end portion of the first conduit on the side, through which the coating liquid is discharged, is inserted into the housing unit without connection thereto, so that the coating liquid is supplied into the housing unit through an opening portion formed, in the end portion (see JP-2007-209984 A and JP-2012-75978 A).

For the coating apparatus of the above type, there is also proposed a configuration, in which the first conduit has a linear shape in the same manner as above, the housing unit has a through hole in a side wall on a bottom wall side, and the opening portion of the end portion of the first conduit on the side through which the coating liquid is discharged is connected to the through hole, so that the coating liquid is supplied into the housing unit through, the opening portion and the through hole (see JP-9(1997)-206657 A).

In the coating apparatus as described in JP-2007-209984 and 2012-75978 A, when the supply of the coating liquid, which has been stopped, is subsequently resumed, air bubbles may be mixed into the coating liquid, which may result in production of a coating film with its quality degraded, such as a coating film having a thickness smaller than a desired thickness or a coating film hardly exerting a desired performance.

On the other hand, in the coating apparatus as described in JP-9(1997)-208657 A, the first conduit is connected to the bottom surface side of the housing unit so that a coating film with air hubbies mixed therein is less likely to be produced even when the supply of the coating liquid, which has been stopped, is subsequently resumed. However, this coating apparatus necessitates connection between the housing unit and the first conduit, and hence involves troublesome apparatus maintenance due to such configuration. Moreover, it is necessary to release the aforesaid connection in order to clean the first conduit. The apparatus maintenance is also troublesome from this point of view.

In view of the above circumstances, it is an object of the present invention to provide a coating apparatus that is capable of producing a coating film with its quality suppressed from being degraded due to mixture of air bubbles, and is easy to perform the apparatus maintenance, and a method for producing a coating film using the coating apparatus.

### SUMMARY OF THE INVENTION

The following presents a simplified summary of the invention disclosed herein in order to provide a basic understanding of some aspects of the invention. This summary is not an extensive overview of the invention. It is intended to neither identity key or critical elements of the invention nor delineate the scope of the invention. Its sole purpose is to present some concepts of the invention in a simplified form as a prelude to the more detailed description that is presented later.

According to the present invention, there is provided a coating apparatus that includes: a coating unit that coats a target to be coated with a coating liquid; a housing unit that houses the coating liquid to be supplied to the coating unit; and a conduit that supplies the coating liquid from above into the housing unit, in which the conduit has an end portion on a side through which the coating liquid is discharged, the end portion being provided with an opening portion through which the coating liquid is discharged, and a bent portion that is bent so as to have the opening portion directed upward.

In the coating apparatus having the above configuration, the coating liquid may have a viscosity of 0.5 Pa·s or more.

According to tire present invention, there is also provided a method for producing a coating film, which includes, while using the coating apparatus, coating the target to be coated with the coating liquid by the coating unit, thereby forming a coating film on the target to be coated.

In the coating film production method having the above configuration, the coating liquid may have a viscosity of 0.5 Pa·s or more.

### BRIEF DESCRIPTION OF DRAWINGS

The foregoing and other features of the present invention will become apparent from the following description and drawings of an illustrative embodiment of the invention in which:

FIG. 1 is a schematic side view showing a coating apparatus according to one embodiment of the present invention;

FIG. 2 is a schematic side view showing the periphery of a conduit in the coating apparatus of the embodiment;

FIG. 3 is a schematic side view showing a coating apparatus according to another embodiment of the present invention;

FIG. 4 is a schematic side view showing the periphery of a conduit in a conventional coating apparatus; and

FIG. 5 is a schematic side view showing the state in which air bubbles axe mixed into the conduit of the conventional coating apparatus and the coating liquid with the air hubbies mixed therein is discharged from the conduit.

### DESCRIPTION OF EMBODIMENTS

Now, the description is made for a coating apparatus of an embodiment of the present invention. In the present embodiment, an example in which a sheet member is used as a target to be coated, but there is no limitation on the target to be coated.

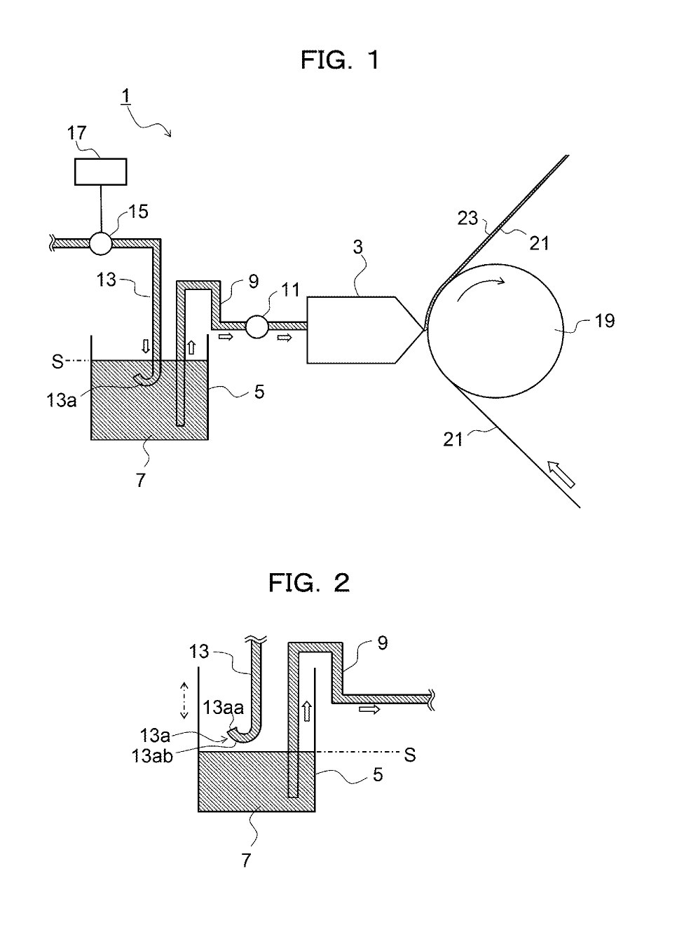

As shown in FIG. 1 and FIG. 2, a coating apparatus 1 of the present embodiment includes a coating unit 3 that discharges a coating liquid 7 onto a strip-shaped sheet member 21 as a target to be coated to coat the sheet member 21, thereby forming a coating film 23 on the sheet member 21, a housing unit 5 that houses the coating liquid 7 supplied to the coating unit 3, a first conduit (i.e., the conduit) 13 that supplies the coating liquid 7 from above into the housing unit 5, a first pump 15 that is a first supply unit, which is disposed in the first conduit 13 to supply the coating liquid 7 into the housing unit 5, a control unit 17 that changes the amount of the coating liquid 7 supplied by the first pump 15, a second conduit 9 that is connected to the housing unit 5 and the coating unit 3 to supply the coating liquid 7 from the housing unit 5 to the coating unit 3, and a second pump 11 that is a second supply unit, which is disposed in the second conduit 9 to supply the coating liquid 7 from the housing unit 5 to the coating unit 3.

The coating apparatus 1 includes a support part 19 that moves the sheet member 21 in the longitudinal direction of the sheet member 21 relative to the coating unit 3, while supporting the sheet member 21. The coating unit 3 is configured to coat the sheet member 21 with the coating liquid 7, while the sheet member 21 is being moved relative to the coating unit 3.

Further, the coating apparatus 1 has a configuration in which an end portion 13a of the first conduit 13 on a side through which the coating liquid 7 is discharged (a discharging side end portion) has an opening portion 13aa through which the coating liquid 7 is discharged, and a bent portion 13ab that is bent so as to have the opening portion 13aa directed upward.

The coating unit 3 is configured to sequentially coat the sheet member 21 with the coating liquid 7 supplied from the housing unit 5, the sheet member 21 being moved relative to the coating unit 3. An example of the coating unit 3 includes a die having a slot through which the coating liquid 7 is discharged. The coating apparatus 1 provided with a die as the coating unit 3 is called as die coater.

The second conduit 9 is disposed at each of a portion between the housing unit 5 and the second pump 11 and a portion between the second pump 11 and the coating unit 3 to form a passage that enables the coating liquid 7 to transfer from the housing unit 5 to the coating unit 3 via the second pump 11.

Examples of a material for forming the second conduit 9 include a metal material, a composite material formed from a mixture of resin and metal, and a resin material.

The second pump 11 is configured to supply the coating liquid 7 from the housing unit 5 to the coating unit 3. Examples of the second pump 11 include conventionally known pumps, such as gear pumps, diaphragm pumps, plunger pumps, and uniaxial eccentric screw pumps.

The housing unit 5 is configured to house the coating liquid 7 to be applied onto the sheet member 21. Examples of the housing unit 5 include a metal tank and the like.

The first conduit 13 is configured to form a passage that enables the coating liquid 7 to transfer from a non-illustrated coating liquid housing tank to the housing unit 5. The first conduit 13 is configured to supply the coating liquid 7 from above into the housing unit 5, and specifically to supply the coating liquid 7 from above the bottom surface of the housing unit into the housing unit 5.

The discharging side end portion 13a of the first conduit 13 includes an opening portion 13aa through which the coating liquid 7 is discharged, and a bent portion 13ab that is bent so as to have the opening portion 13aa directed upward. Specifically, in the present embodiment, the discharging side end portion 13a of the first conduit 13 has a J-like shape. Further, the discharging side end portion 13a of the first conduit 13 is inserted into the housing unit 5 without being connected thereto.

According to the coating apparatus 1 provided with the first conduit 13 having the above configuration, the coating liquid 7 is made to flow into the first conduit 13 from an opening portion (not shown) in an end portion (an inflow side end portion) on a side of the first conduit 13 through which the coating liquid 7 flows, and the inflows coating liquid 7 is discharged through the opening portion 13aa of the discharging side end portion 13a so that the coating liquid 7 is supplied into the housing unit 5.

Examples of the material for forming the first conduit 13 include a metal material, a composite material formed from a mixture of resin and metal, and a resin material.

The first pump 15 is configured to supply the coating liquid 7 from a non-illustrated coating liquid housing tank to the housing unit 5. Examples of the first pump 15 include conventionally known pumps, such as gear pumps, diaphragm pumps, plunger pumps, and uniaxial eccentric screw pumps.

The control unit 17 is capable of changing the amount of the coating liquid 7 supplied by the first pump 15.

Specifically, in the present embodiment, the control unit 17 has a function of supplying the coating liquid 7 to the first pump 15 on the basis of a preset time schedule, stopping the supply and then resuming the supply of the coating liquid 7 (that is, the function of supplying the coating liquid 7 intermittently) so as to supply a certain amount of the coating liquid 7 which is preset on the basis of, for example, the result of a preliminary experiment (by adjusting the supply speed, for example).

In the present invention, there is no limitation on the configuration for supplying the coating liquid. For example, the control unit 17 may have a function of increasing and decreasing the amount of the costing liquid 7 supplied into the housing unit 5 by the first pump 15 on the basis of not the preset time schedule, but the amount of the coating liquid 7 left in the housing unit 5 (or the amount of the coating liquid 7 consumed at the coating unit 3).

The supporting part 19 is configured to support the sheet member 21, which moves in the longitudinal direction, from the side opposite to the coating unit 3. Examples of the support member 19 include a roller and the like.

The coating liquid 7 is configured to contain a curing component, be coated on the sheet member 21, and be cured on the sheet member 21. Examples of the coating liquid 21 include a polymer solution and the like. Examples of the curing component include a thermoset material, ultraviolet curable material and an electron curable material.

There is no limitation to the coating liquid 7. However, the higher the viscosity of the coating liquid 7 is, the more hardly air bubbles entrained in the coating liquid 7 are removed, so that air entrained in the coating liquid 7 tends to easily stay in the coating liquid 7 in the form of air bubbles.

Accordingly, from this point of view, the coating liquid 7 has a viscosity of, preferably 0.5 Pa·s or more, and more preferably 0.5 to 30 Pa·s. The viscosity is a value measured under the conditions with a shear velocity l(l/s) using a rheometer (Model RS1, manufactured by Haake).

When the coating liquid 7 has a viscosity of 0.5 Pa·s or more, air entrained in the coating liquid 7 is easy to stay therein in the form of air hubbies. However, according to the coating apparatus 1 of the present embodiment, even if the coating liquid 7 having such a viscosity is used, it is possible to suppress air from being entrained in the coating liquid 7 and hence air bubbles from being mixed into the coating liquid 7, which is significantly useful.

In the present embodiment, the first conduit 13 has a circular cross sectional shape, but there is no limitation to the cross sectional shape.

Further, there is no limitation to the inner diameter of the first conduit 13. However, in order to produce an advantageous effect of making it hard for air bubbles to be entrained in the coating liquid 7 within the first conduit 13, the inner diameter of the first conduit 13 is preferably 8 to 50 mm. With the first conduit having an inner diameter of 8 to 50 mm, it is possible to suppress air bubbles to be entrained in the coating liquid 7 even if the first conduit 13 has such an inner diameter at which air bubbles are conventionally easy to be entrained.

Examples of the sheet member 21 include a resin film and the like. FIG. 1 shows one form of the sheet member 21, which is flexible and has as elongated shape. As an alternative to this, the sheet member 21 may be a single plate shaped member, or a non-flexible member.

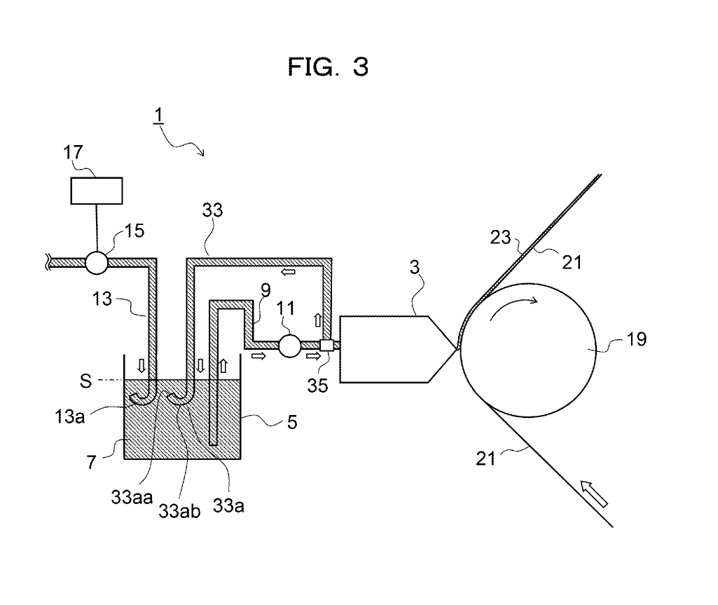

In the present embodiment, the coating apparatus 1 has a configuration having the first conduit 13 as a conduit for supplying the coating liquid 7 into the housing unit 5. However in the present invention, in place of the sole employment of the first conduit 13, the coating apparatus 1 may employ the following configuration in conjunction with the first conduit 13, as shown in FIG. 3. Specifically, the coating apparatus 1 may be configured by including a third conduit 33 that is branched from the second conduit 9 (specifically, branched from the second conduit 9 at the downstream side of the second pump 11) to form a passage that returns part of the coating liquid 7, which is moving toward the coating unit 3, into the housing unit 5, and a three-way valve 35 that is disposed at a branching portion of the second conduit 9 and the third conduit 33 to supply the coating liquid 7 to either the coating unit 3 or the housing unit 5, in which an end portion 33a of the third conduit 33 on the side through which the coating liquid 7 is discharged has an opening portion 33aa through which the coating liquid 7 is discharged, and a bent portion 33ab that is heat so as to have the opening portion 33aa directed upward.

Next, the description is made for the operational function of the coating apparatus 1.

Assuming that, for example, in the coating apparatus 1, the coating liquid 7 is supplied into the housing unit 5 in a state where the housing unit 5 does not house the coating liquid 7 or the liquid level S of the coating liquid 7 is positioned below the opening portion 13aa of the first conduit 13 (see FIG. 2), even if the coating liquid 7 is housed. From this state, when the coating liquid 7 is supplied into the housing unit 5 through the first conduit 13 by the first pump 15, the liquid level S of the coating liquid 7 rises and hence the liquid level S is positioned above the opening portion 13aa (see FIG. 1). From this state, the coating liquid 7 is supplied from the housing unit 5 to the coating unit 3 by the second pump 11, and the coating unit 3 starts its coating operation to the sheet member 21, thereby discharging the coating liquid 7 onto the sheet member 21 from the coating unit 3. Then, as the coating operation continues, the liquid level S of the coating liquid 7 lowers below the opening portion 13aa.

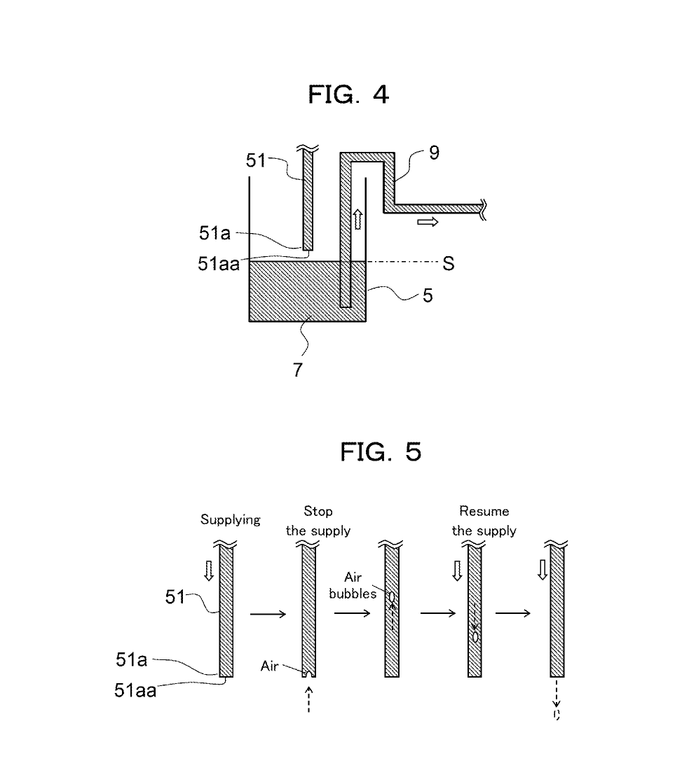

Here, for example, when a conventional conduit 51 having a linear shape as shown in FIG. 4 and FIG. 5 is employed in place of the first conduit 13, an end portion 51a of the conduit 51 on the side through which the coating liquid 7 is discharged is directed downward, and therefore an upwardly directed passage is formed inside the end portion 51a from the opening portion 51aa. With this configuration, air of which a specific gravity is smaller than the coating liquid 7 is easy to be entrained in the coating liquid 7 from the opening portion 51aa due to its buoyancy.

Specifically, for example, in the configuration where the conventional conduit 51 having a linear shape as shown in FIG. 4 and FIG. 5 is employed, when the liquid level S of the costing liquid 7 is positioned below the end portion 51a of the conduit 51, air bubbles are forced downward due to the supply of the coating liquid 7 during the coating liquid 7 is supplied. Thus, it is less likely that air is entrained inside the conduit 51a from the opening 51aa (see the leftmost view of FIG. 5).

Meanwhile, when the supply of the coating liquid 7 to the housing unit 5 is stopped in a state where the liquid level S of the coating liquid 7 is positioned below the one end portion 51a (note that the supply of the coating liquid to the coating unit 8 from the housing unit 5 continues at this time), air is easily entrained inside the conduit 51a from the opening 51aa due to its buoyancy (see the second left view of FIG. 5). Further, air entrained into the lower end portion 51a from the opening 51aa rises upward in the coating liquid 7 due to its buoyancy and stays in the coating liquid 7 within the conduit 51 (see the third left view of FIG. 5). Then, when the supply of the coating liquid 7 into the housing unit 5 is resumed, the coating liquid 7 with air bubbles mixed thereinto is supplied into the housing unit 5 through the conduit 51 (see the fourth left and fifth left views of FIG. 5), with the result that the coating liquid 7 with air bubbles mixed thereinto is supplied from the housing unit 5 to the coating unit 3. Whereby the coating liquid 7 with air bubbles mixed thereinto is coated on the sheet member 21 and hence the coating film 28 with air bubbles mixed thereinto is produced.

Contrarily to the above, in the coating apparatus 1 of the present embodiment, in which the discharging side end portion 13a of the first conduit 13 has the opening portion 13aa through which the coating liquid 7 is discharged, and the bent portion that is bent so as to have the opening portion 13aa directed upward, there is formed a passage that extends downwardly as it advances away from the opening portion 13aa inside the first conduit 13. Whereby air having a specific gravity smaller than the coating liquid 7 is difficult to be entrained into coating liquid 7 from the opening portion 13aa. Thus, it is possible to suppress air babbles from being mixed into the coating liquid 7.

Specifically, according to the coating apparatus 1 of the present embodiment, there is formed the passage that extends downward as it advances away from the opening portion 13aa in the discharging side end portion 13a of the first conduit 13 by the above described configuration, in which the discharging side end portion 13a of the first conduit 13 on the side through which the coating liquid 7 is discharged has the opening portion 13aa through which the coating liquid 7 is discharged, and the bent portion 13ab that is bent so as to have the opening portion 13aa directed upward. Whereby, for example, when the supply of the coating liquid 7 is stopped in the state where the liquid level S of the coating liquid 7 is positioned below the opening portion 13aa, air is difficult to be entrained into the coating liquid 7 from the opening portion 13aa due to its buoyancy, and thus, air bubbles can be suppressed from being mixed into the coating liquid 7. Thus, it is possible to suppress air bubbles from being mixed into the coating liquid 7, and therefore, even if the supply of the coating liquid is resumed, it is possible to easily produce the coating film 23 with air bubbles suppressed from being mixed.

Thus, according to the coating apparatus 1 of the present embodiment, it is possible to securely suppress air bubbles from being mixed into the coating liquid 7, and produce the coating film 23 with its quality suppressed from being degraded due to the air bubbles by suppressing the mixture of air bubbles.

Thus, the coating film 23 with its quality suppressed from being degraded due to air bubbles can be obtained by suppressing the mixture of the air bubbles.

Further, the maintenance of the coating apparatus 1 can be easily performed since air bubbles can be suppressed from being mixed into the coating liquid 7 even without providing a through hole in the housing unit 5 and connecting the first conduit 13 to the through hole.

Thus, according to the coating apparatus 1 of the present embodiment, it is possible to produce the coating film 23 with its quality suppressed from being degraded due to the mixture of air bubbles, and allow the maintenance of the coating apparatus 1 to be easily performed.

In FIG. 1. the first conduit 13 positioned within the housing unit 5 is disposed along the vertical direction as a whole. However, there is no limitation to the arrangement of the first conduit 13, as long as the first conduit 13 is disposed so as to have the discharging side end portion 13a positioned inclined relative to the horizontal direction and hereby positioned at a relatively lower side within the housing unit 5.

Also, there is no limitation on how far the opening portion 13aa is upwardly bent, as long as the opening portion 13aa is directed upwardly than the horizontal direction.

Next, the description is made for the method for producing a coating film using the coating apparatus 1 of the present embodiment.

The method for producing a coating film according to the present embodiment includes: while using the coating apparatus 1, coating the sheet member 21 as the target to be coated with the coating liquid 7 by the coating unit 3, thereby forming the coating film 28 on the sheet member 21.

According to the coating film production method having the above configuration, it is possible to securely suppress air bubbles from being mixed into the coating liquid 7 in the same manner as above. Whereby it is possible to produce the coating film with its quality suppressed from being degraded due to the mixture of the air bubbles, and allow the maintenance of the coating apparatus to be easily performed.

In the coating film production method having the above configuration, the coating liquid 7 may have a viscosity of 0.5 Pa·s or more. In this case, air entrained into the coating liquid 7 easily stays in the form of air bubbles. However, according to the production method of the present embodiment, even if the coating liquid 7 in which air entrained in this way easily stays in the form of air bubbles is used, it is possible to suppress air from being entrained in the coating liquid 7 and thus suppress air bubbles from being mixed into the coating liquid 7. Thus, the coating film production method is very useful.

As described above, the coating apparatus 1 of the present embodiment includes the coating unit 3 that coats a sheet member (target to be coated) 21 with the coating liquid 7, the housing unit 5 that houses the coating liquid 7 to be supplied to the coating unit 3, and the first conduit 13 that supplies the coating liquid 7 into the housing unit 5 from above, the discharging side end portion 13a of the first conduit 13 on the side through which the coating liquid 7 is discharged having the opening portion 13aa through which the coating liquid 7 is discharged, and the bent portion 13ab that is bent so as to have the opening portion 13aa directed upwardly.

According to the coating apparatus 1 of the present embodiment, it is possible to securely suppress air bubbles from being entrained into the coating liquid 7, and whereby produce the coating film 23 with its quality suppressed from being degraded due to the mixture of air bubbles.

Since it is possible to suppress air bubbles from being mixed into the coating liquid 7 even without providing a through hole in the housing unit 5 and connecting the conduit to this through hole, the maintenance of the coating apparatus 1 can be easily performed.

Thus, according to the coating apparatus 1 of the present embodiment, it is possible to obtain a coating film 28 with its quality suppressed from being degraded due to the mixture of air bubbles, and allow the maintenance of the coating apparatus 1 to be easily performed.

The method for producing the coating film 28 of the present embodiment includes, while using the coating apparatus 1, coating the sheet member 21 with the coating liquid 7 by the coating unit 3, thereby forming the coating film 23 on the sheet member 21.

According to the above configuration, it is possible to securely suppress air bubbles from being mixed into the coating liquid 7 and thereby produce the coating film 23 with its quality suppressed from being degraded due to the mixture of the air bubbles. Furthermore, it is possible to allow the maintenance of the coating apparatus to be easily performed.

As described above, according to the coating apparatus 1 and the method for producing the coating film 23 of the present embodiment, it is possible to produce the coating film 23 with its quality suppressed from being degraded due to the mixture of air bubbles, and allow the maintenance of the apparatus to fee easily performed.

The costing apparatus and the coating film production method of the present invention are as described above. The present invention is not necessarily limited to the above embodiment and the design can be appropriately modified within the scope intended by the present invention.

The operational advantage of the present invention is also not limited to the foregoing embodiment.

In other words, the embodiment disclosed herein should be construed in all respects as illustrative hot not limiting. The scope of the present invention is not indicated by the foregoing description but by the scope of the claims. The scope of the present invention is intended to include all the modifications equivalent in the sense and the scope to the scope of the claims.

What is claimed is:

1. A coating apparatus comprising:
a coating unit that coats a target to be coated with a coating liquid;
a housing unit that houses the coating liquid to be supplied to the coating unit; and
a conduit that supplies the coating liquid from above into the housing unit;
wherein the conduit has an end portion on a side through which the coating liquid is discharged, the end portion being provided with an opening portion through which the coating liquid is discharged, and a bent portion that is bent so as to have the opening portion directed upward.

2. The coating apparatus according to claim 1, wherein the coating liquid has a viscosity of 0.5 Pa·s or more.

3. A method for producing a coating film comprising:
while using the coating apparatus of claim 1, coating the target to be coated with the coating liquid by the coating unit, thereby forming a coating film on the target to be coated.

4. A method for producing a coating film comprising:
while using the coating apparatus of claim 2, coating the target to be coated with the coating liquid by the coating unit, thereby forming a coating film on the target to be coated.
